(19) United States
(12) Patent Application Publication
(10) Pub. No.: US 2005/0263303 A1
(43) Pub. Date: Dec. 1, 2005

(54) Rotary impact tool

(75) Inventors: Hidenori Shimizu, Hikone-shi (JP); Toshiharu Ohashi, Sakata-gun (JP); Kozo Kawai, Neyagawa-shi (JP); Yoshinori Sainomoto, Sanda-shi (JP); Fumiaki Sawano, Hikone-shi (JP); Hiroshi Miyazaki, Hikone-shi (JP); Tadashi Arimura, Kyoto-shi (JP); Tatsuhiko Matsumoto, Habikino-shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/126,338

(22) Filed: May 11, 2005

(30) Foreign Application Priority Data
May 12, 2004 (JP) 2004-142843

(51) Int. Cl. B25D 1/00

(52) U.S. Cl. 173/2; 173/176

(57) ABSTRACT

A rotary impact tool can be used in a work especially precision or finishing of fastening is important. The rotary impact tool comprises a rotary driving mechanism including a driving source for rotating a driving shaft, a hammer fixed on the driving shaft, an output shaft to which a driving force is applied by impact blow of the hammer, a torque setting unit used for setting a fastening torque, a processor for calculating fastening torque from impact blow of the hammer, a rotation speed setting unit used for setting rotation speed of the driving shaft, and a controller for rotating the driving shaft of the rotary driving mechanism in a rotation speed set in the rotation speed setting unit and for stopping rotation of the driving shaft of the rotary driving mechanism when the fastening torque calculated in the processor becomes equal to or larger than a reference value of fastening torque previously set in the torque setting unit.

### BACKGROUND OF THE INVENTION

1. Field of the Invention

The present invention relates to a rotary impact tool such as an impact wrench or an impact driver used for fastening or loosening of fastening member such as a screw, a bolt or a nut.

2. Description of the Related Art

A rotary impact tool which can stop the driving of the motor automatically when a fastening torque reaches to a predetermined value is conventionally provided. In the actual fastening work, there, however, are many cases that the fastening torque of the fastening member is insufficient for preventing the over fastening. For preventing occurrence of the insufficient fastening torque, Japanese Laid-Open Patent Publication No. 2001-129767 shows a rotary impact tool which can fasten the fastening member a little more further to stop the fastening of the fastening member in normal fastening torque (it is called tight fastening mode).

In such a conventional rotary impact tool, when the user holds a main switch on after stopping to motor when a controller judges that the fastening torque reaches to a predetermined torque, the controller restarts the driving of the motor so as to apply a predetermined number of impact blows of a hammer, so that the tight fastening can be performed. In tight fastening mode, the impact energy is generally made smaller, so that it is possible to prevent the over fastening.

In such a conventional rotary impact tool with the tight fastening mode, the tight fastening mode cannot be transitive when the switching on state of the main switch after stopping the driving of the motor is maintained. Thus, if the user judges that the fastening of the fastening member is completed due to stop of the driving of the motor, the tight fastening bode cannot be transitive.

### SUMMARY OF THE INVENTION

A purpose of the present invention is to provide a rotary impact tool, which has a tight fastening mode and the tight fastening mode can be transitive properly.

A rotary impact tool in accordance with an aspect of the present invention comprises: a rotary driving mechanism including a motor for rotating a driving shaft; a hammer engaged with the driving shaft; an output shaft to which a driving force is applied by impact blow of the hammer; a main switch operated by a user for controlling fastening operation; and a controller for controlling on and off of the motor, and having a normal fastening mode and a tight fastening mode.

The rotary impact tool further comprises a term sensor for sensing terms of switching on and off of the main switch is further comprised. The term sensor senses a term between a time when the main switch is switched off and a time when the main switch is switched on next, and the controller gives transition to the tight fastening mode corresponding to the term sensed by the term sensor.

By such a configuration, when a user switches on the main switch in a predetermined term after completing a normal fastening operation in the normal operation mode, it is possible to give transition to the tight fastening mode so as to perform a tight fastening operation. Thus, even when it is found that the fastening of a fastening member such as a screw, a bolt or a nut is insufficient after judging that the fastening operation has been completed, it is possible further to fasten the fastening member with a predetermined fastening torque. Thus, the tight fastening operation can be performed preferably. Furthermore, a wood screw or a tapping screw can be fastened completely with using the tight fastening mode.

### BRIEF DESCRIPTION OF THE DRAWINGS

FIG. 1 is a block diagram showing a configuration of a rotary impact tool in accordance with an embodiment of the present invention;

FIG. 2 is a schematic sectional side view showing the configuration of the rotary impact tool in the embodiment;

FIG. 3 is a sectional side view showing an example of a configuration of a driving mechanism of the rotary impact tool in the embodiment;

FIG. 4 is a front view showing an example of a torque setting switch and a tight fastening mode setting switch of the rotary impact tool in the embodiment;

FIG. 5 is a front view showing another example of a torque setting unit and a tight fastening mode setting switch of the rotary impact tool in the embodiment;

FIG. 6 is a time chart showing an example of an operation of the rotary impact tool in the embodiment;

FIG. 7 is a time chart showing another example of an operation of the rotary impact tool in the embodiment;

FIG. 8 is a time chart showing still another example of an operation of the rotary impact tool in the embodiment;

FIG. 9 is a time chart showing still another example of an operation of the rotary impact tool in the embodiment;

FIG. 10 is a time chart showing still another example of an operation of the rotary impact tool in the embodiment; and

FIG. 11 is a time chart showing still another example of an operation of the rotary impact tool in the embodiment.

### DETAILED DESCRIPTION OF THE EMBODIMENT

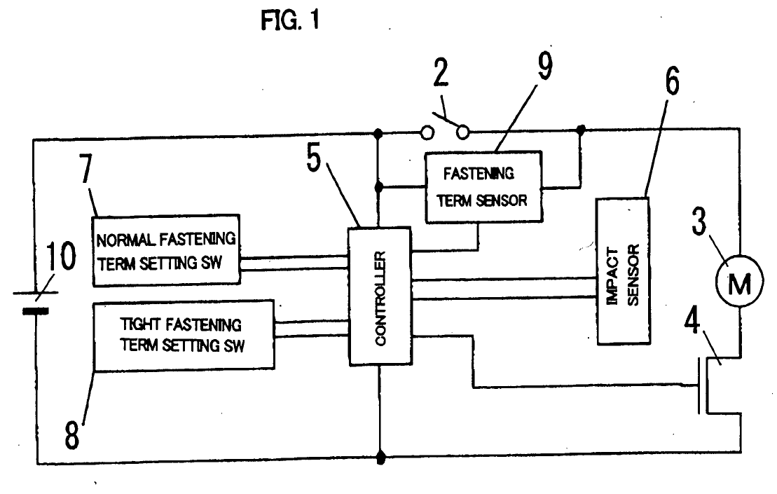

A rotary impact tool in accordance with an embodiment of the present invention is described. A block configuration of the rotary impact tool is shown in FIG. 1. The rotary impact tool comprises a main switch 2 used for controlling the fastening operation, a motor 3, a switching device 4 used for on and off of driving the motor 3, a controller (control circuit) 5, an impact sensor 6, a normal fastening term setting switch 7, a tight fastening term setting switch 8, a fastening term sensor (sensing circuit) 9, and a battery 10 as a power source. The battery 10, the main switch 2, the motor 3 and the switching device 4 are connected in series, and the series circuit is connected in parallel with the controller 5.

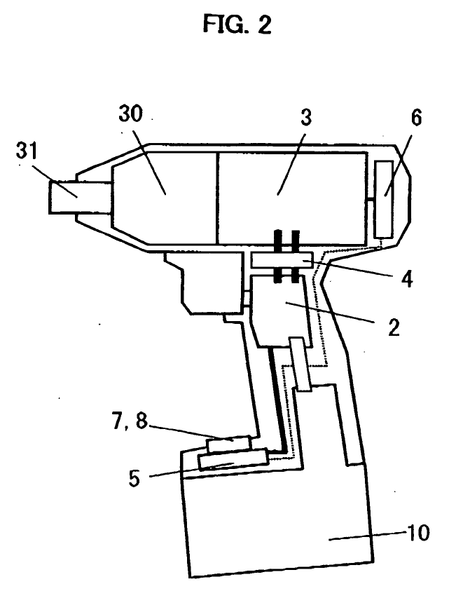

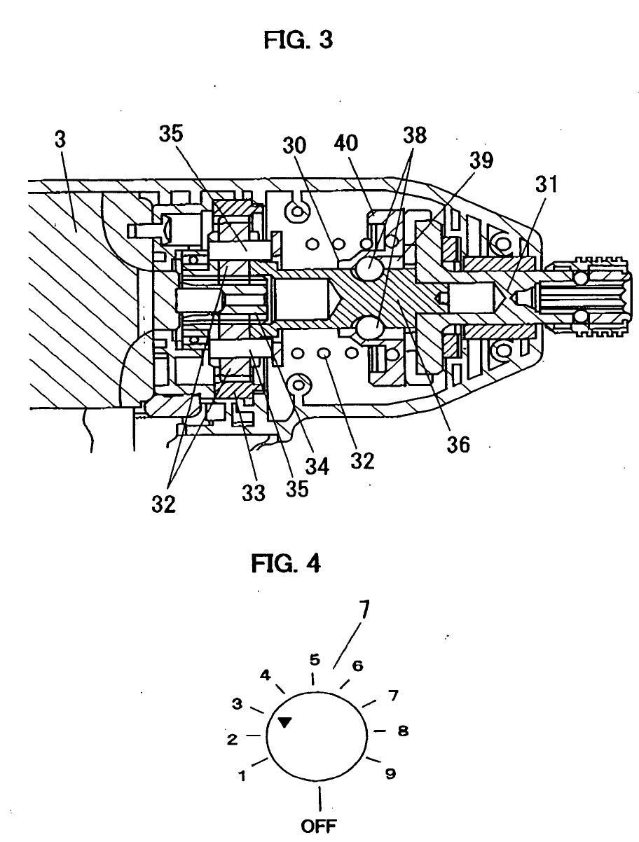

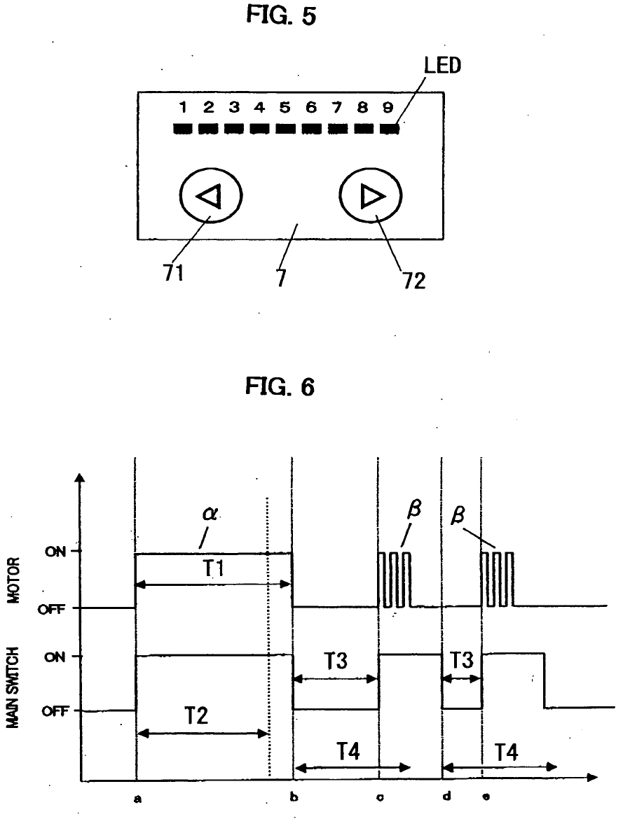

FIG. 2 shows schematic configuration of the rotary impact tool, and FIG. 3 shown specific example of a driving mechanism 30 for performing fastening operation of a fastening member such as a screw, a bolt or a nut by impact blow. As shown in FIG. 3, a reducer is configured by a sun gear 34, a pair of planet gears 32, and an internal gear 33. Rotation shafts 35 of the planet gears 32 are borne on a driving shaft 36. Rotation force of the motor 3 is transmitted to the driving shaft 36 via the reducer. A hammer 40 is engaged with an outer face of the driving shaft 36 via ball bearings 38 and a cam 39. A spring 37 is further provided between the driving shaft 36 and the hammer 40 for pressing the hammer 40 forward. The hammer 40 further has at least one engaging portion engaging with an anvil provided on an output shaft 31.

When no load is applied to the output shaft 31, the hammer 40 and the output shaft 31 are integrally rotated by the driving force of the motor 3. When a load equal to or larger than a predetermined value is applied to the output shaft 31, the hammer moves backward against the pressing force of the spring 37. When the engagement of the hammer 40 with the anvil of the output shaft 31 is released, the hammer 40 moves forward with rotation and applies impact blow in the rotation direction to the anvil of the output shaft 31, so that the output shaft 31 can be rotated.

As for the impact sensor 6, not only a device such as a microphone or an acceleration sensor which can directly sense the occurrence of the impact blow can be used, but also an encoder for sensing the rotation of the motor can be used, since the rotation speed of the motor varies at a moment of the impact blow.

The fastening time sensor 9 is connected in parallel with the main switch 2 so as to measure on time and off time of the main switch 2.

As for the normal fastening term setting switch 7 and the tight fastening term setting switch 8, a type of a rotary switch shown in FIG. 4 or a type with a level meter of LED (light emitting diode) arrays and arrow keys 71 and 72 used for increase or decrease the level of the indication of the level meter can be used.

The normal fastening term setting switch 7 is used for setting or changing a term T2, for example, shown in FIG. 6, details of which will be described below. The tight fastening term setting switch 8 is used for setting or changing a term T4, shown in FIG. 6. The term T4 set in the tight fastening term setting switch 8 can be increased in phase, for example, when the tight fastening term setting switch 8 is set to be phases 1, 2, 3 . . . and 9, the term T4 is set to be 0.5 sec, 0.75 sec, 1 sec . . . and 2.5 sec.

In such a rotary impact tool, when the fastening operation of a fastening member such as a screw, a bolt or a nut, the motor 3 is driven for staring impact blows of the hammer 40 according to the switch on of the main switch 2, as shown in, for example, FIG. 6. When a user judges that the fastening operation of the fastening member is completed and switches off the main switch 2, the driving of the motor 3 is stopped. The normal operation term sensing circuit 9 measures an actual fastening term T1 while an actual fastening operation. When the actual fastening term T1 is longer than the normal fastening term T2, the controller 5 judges that the normal fastening operation α has been completed.

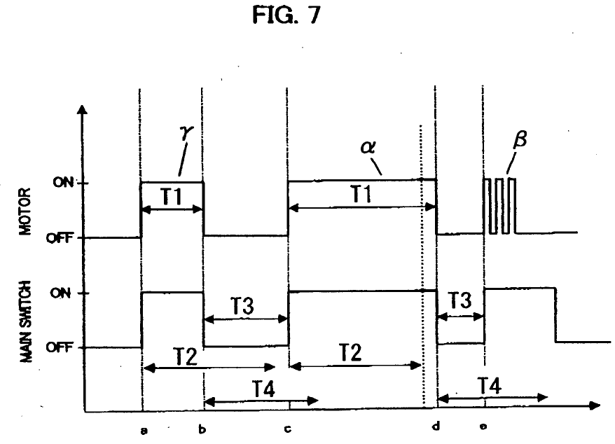

When the actual fastening term T1 is shorter than the normal fastening term T2, as shown in FIG. 7, the controller 5 judges that an initial operation γ has been completed. As for the initial operation γ, when the fastening member is a wood screw or a tapping screw, at least a part of screw-threaded portion of the screw is engaged with an object to be fastened. When the fastening member is a bolt or a nut, the bolt and the nut are incompletely engaged with each other, as the initial operations γ.

When the controller 5 judges that the normal fastening operation a has been completed, a term T3 between the above-mentioned switching off of the main switch 2 to switching on of the main switch 2 next time is measured. When the term T3 is shorter than the above-mentioned term T4, the controller 5 judges that the user wishes to perform the tight fastening operation, and it drives the motor 3 in the tight fastening mode. In the tight fastening mode, it is possible that the impact operation of the hammer can be limited due to the limitation of the number of impact blows of the hammer 40, a term for supplying driving current to the motor 3, and the rotation speed of the motor 3. Furthermore, the limitation of the number of impact blows of the hammer 40, a term for supplying driving current to the motor 3, and the rotation speed of the motor 3 can be limited independently or combination of at least two of them. By the way, the limitation of the rotation speed of the motor 3 is controlled by PWM (Pulse Width Modulation) control for intermittently switching on and off the switching device 4 used for supplying the driving current to the motor 3. By limiting the rotation speed of the shaft of the motor 3, the impact force of the hammer 40 can be controlled.

The control of the tight fastening operation due to the number of impact blows of the hammer 40 can be performed with sensing the occurrence of the impact blow of the hammer 40 by the impact sensor 6. The control of the tight fastening operation due to the term of the fastening operation can be performed with the measurement of the term by the fastening term sensing circuit 9.

When the tight fastening operation β in the tight fastening mode is performed to stop the driving of the motor 3 due to the quantity of energy due to the impact blows of the hammer 40, it is possible alternative to fix the quantity of the impact blows of the hammer 40 or to vary the quantity of energy due to the impact blows of the hammer 40 corresponding to a length of the normal fastening term T2 or the total number of impact blows of the hammer 40 while the normal fastening operation. It is because, when the normal fastening term T2 becomes longer, the quantity of energy due to the impact blows of the hammer 40 becomes larger just before the completion of the fastening operation of the fastening member.

When the number of the impact blows of the hammer 40 is varied corresponding to the normal fastening term T2 in the tight fastening mode, it is amended that the impact number is two when the normal fastening term T2 is in a range of 0.5 to 1.0 sec, the impact number is three when the normal fastening term T2 is in a range of 1.0 to 1.5 sec, the impact number is four when the normal fastening term T2 is in a range of 1.5 to 2.0 sec, and the impact number is ten when the normal fastening term T2 is equal to or larger than 5.0 sec. When the number of the impact blows of the hammer 40 is varied corresponding to the total number of the impact blows of the hammer 40, it is amended that the impact number is two when the total number of the impact blows of the hammer 40 is less than five, the impact number is three when the total number of the impact blows of the hammer 40 is in a range of six to ten, the impact number is four when the total number of the impact blows of the hammer 40 is in a range of eleven to twenty, and the impact number is ten when the total number of the impact blows of the hammer 40 is equal to or larger than fifty.

In addition, when the term T3 is longer than the term T4, the controller 5 starts to drive the motor 3 in the normal fastening mode, without given transition to the tight fastening mode.

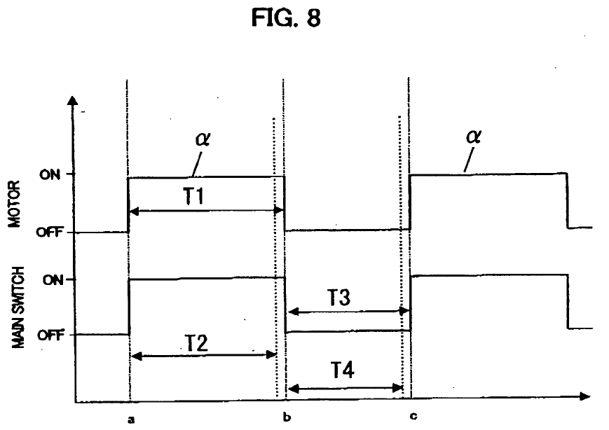

FIG. 8 shows another example that the user judges the sufficient fastening of the fastening member has been completed in the first normal fastening operation and it is no need to transitive to the tight fastening mode. In such a case, a screw, a bolt or a nut will be prepared for next fastening operation in the term T4. The length of the term T4 is supposed for the preparation of the fastening member for next fastening operation. Since the term T4 can be varied corresponding to the substance of the operation, it is possible to prevent the erroneous transition to the tight fastening mode.

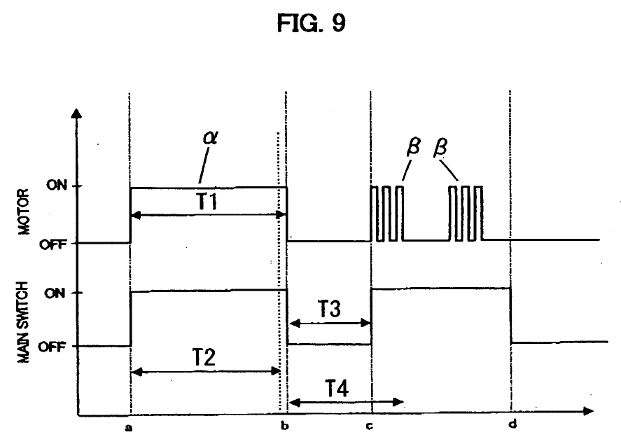

FIG. 9 shows still another example that the user holds the switching on state of the main switch 2 after completing the tight fastening operation in the tight fastening mode. After passing a predetermined term, it restarts the tight fastening operation β.

It is possible that the term T1 can be measured from the start of the impact blow of the hammer 40, instead of the term of switching on state of the main switch 2.

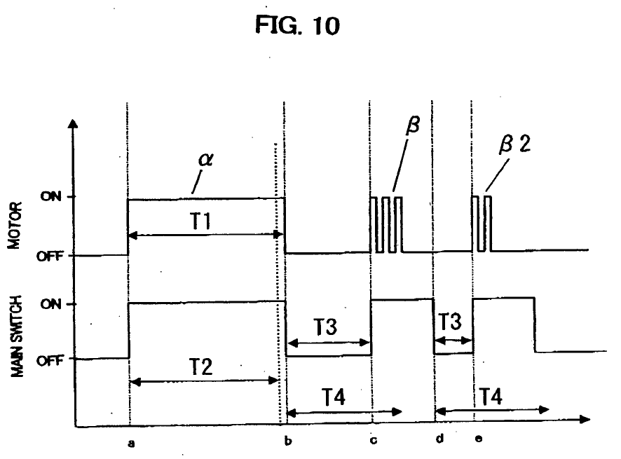

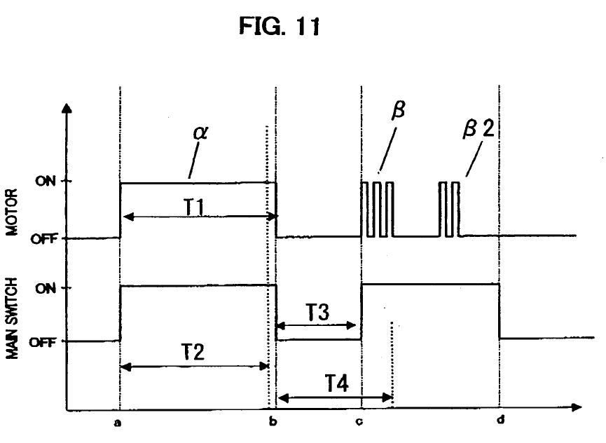

FIGS. 10 and 11 respectively show still other examples. In these examples, the operations before the transition to the tight fastening mode are substantially the same as those in the above-mentioned examples. However, when the tight fastening operations are continuously performed, the quantity of the impact blows of the hammer 40 in the tight fastening operation β2 becomes smaller than that in the former tight fastening operation β. In these cases, the fastening torque of the fastening member can be approached asymptotically to the objective fastening torque or fastening height instead of in phase, so that more proper fastening operation can be performed.

In the above-mentioned description, the examples that have no torque controlling function for controlling the torque for calculating the fastening torque and for stopping the driving of the motor automatically when the calculated fastening torque reaches to a predetermined reference value. It, however, is possible to adopt the feature of the present invention to the rotary impact tool with the torque control function.

This application is based on Japanese patent application 2004-142843 filed May 12, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A rotary impact tool comprising:
a rotary driving mechanism including a motor for rotating a driving shaft;
a hammer engaged with the driving shaft;
an output shaft to which a driving force is applied by impact blow of the hammer;
a main switch operated by a user for controlling fastening operation; and
a controller for controlling on and off of the motor, and having a normal fastening mode and a tight fastening mode; wherein
a term sensor for sensing terms of switching on and off of the main switch is further comprised; and
the term sensor senses a term between a time when the main switch is switched off and a time when the main switch is switched on next; and
the controller gives transition to the tight fastening mode corresponding to the term sensed by the term sensor.

2. The rotary impact tool in accordance with claim 1, wherein
when a term of switching on of the main switch at first is shorter than a predetermined reference time, the controller restricts transition to the tight fastening mode.

3. The rotary impact tool in accordance with claim 1, wherein
when the main switch is switched on in a predetermined term after completing a tight fastening operation, the controller gives transition to the tight fastening mode, again.

4. The rotary impact tool in accordance with claim 1, wherein
the controller repeats tight fastening operation while the switching on of the main switch is maintained while the tight fastening mode.

5. The rotary impact tool in accordance with claim 1, wherein
the controller varies a quantity of impact energy in the tight fastening mode corresponding to a term of switching on of the main switch at first or corresponding to a total number of impact blows of the hammer in the term of switching on of the main switch.

6. The rotary impact tool in accordance with claim 4, wherein
the controller gradually reduces the quantity of impact energy in the tight fastening operation continuously repeated.

7. The rotary impact tool in accordance with claim 2, wherein
when the main switch is switched on in a predetermined term after completing a tight fastening operation, the controller gives transition to the tight fastening mode, again.

8. The rotary impact tool in accordance with claim 2, wherein
the controller repeats tight fastening operation while the switching on of the main switch is maintained while the tight fastening mode.

9. The rotary impact tool in accordance with claim 2, wherein
the controller varies a quantity of impact energy in the tight fastening mode corresponding to a term of switching on of the main switch at first or corresponding to a total number of impact blows of the hammer in the term of switching on of the main switch.

10. The rotary impact tool in accordance with claim 3, wherein
the controller repeats tight fastening operation while the switching on of the main switch is maintained while the tight fastening mode.

11. The rotary impact tool in accordance with claim 4, wherein
the controller varies a quantity of impact energy in the tight fastening mode corresponding to a term of switching on of the main switch at first or corresponding to a total number of impact blows of the hammer in the term of switching on of the main switch.

12. The rotary impact tool in accordance with claim 5, wherein
the controller gradually reduces the quantity of impact energy in the tight fastening operation continuously repeated.
